(19) United States
(12) Patent Application Publication
(10) Pub. No.: US 2007/0236633 A1
(43) Pub. Date: Oct. 11, 2007

(54) Color filter, method for manufacturing color filter having low reflection and liquid crystal display incorporating same

(75) Inventors: Chia-Ming Chan, Miao-Li (TW); Hung-Sheng Cho, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/784,707

(22) Filed: Apr. 9, 2007

(30) Foreign Application Priority Data
Apr. 7, 2006 (TW) 95112488

(51) Int. Cl. G02F 1/1335

(52) U.S. Cl. 349/106

(57) ABSTRACT

A color filter (3) includes a substrate (30); a black matrix (31) deposited on the substrate, defining a plurality of apertures therein; a color layer (32) filled in the apertures of the black matrix; an antireflective layer (33) deposited on the black matrix; and a transparent conductive layer (34) covering the color layer and the antireflective layer.

### BACKGROUND OF THE INVENTION

1. Field of the Invention

The invention generally relates to color filters, methods of manufacturing color filters and associated liquid crystal display (LCD) devices.

2. General Background

In general, a monochrome or a color LCD device has the advantages of thinness, light weight and low power consumption. For this reason, LCD devices are widely used in various types of electronic equipment, from pocket calculators to large-scale office automation equipment.

Conventionally, a color LCD device includes a color filter at a position opposite to a liquid crystal layer. The color filter has three kinds of color (red, green and blue—RGB) resins separated by a black matrix having a plurality of apertures. The visibility of the LCD device mainly depends upon the characteristics of the black matrix of the color filter.

The basic structure of a conventional color filter is shown in FIG. 8. The color filter 20 includes a transparent substrate 24 with a black matrix 23 deposited thereon, the black matrix 23 defining a plurality of apertures (not labeled) therein. RGB color resins 22 are filled in the apertures of the black matrix 23 in a sequential repeating pattern. The RGB color resins 22 filter light beams passing therethrough, thus producing respective RGB color light beams. A transparent electrode layer 21 is provided on the RGB colr resins 22.

The black matrix 23 functions as a light-shielding mask, to improve the contrast ratio of an LCD device using the color filter 20. In particular, the black matrix 23 increases the OD (Optical Density, i.e. light-shielding) value, and reduces optical reflectivity of the top and bottom surfaces thereof. However, the black matrix 23 is conventionally made from a metal whose optical reflectivity is too high, or is made from a resin whose OD value is too low. Thus, modified color filters have been developed to solve the above-described problems.

Referring to FIG. 9, a color filter is illustrated. The color filter 1 has a black matrix 9 formed on a transparent substrate 2. The black matrix 9 comprises a first antireflection film 3, a second antireflection film 4 and a metal screening film 5 formed one on top of the other in that order. The antireflection films 3, 4 are made of different kinds of metallic compounds having mutually different compositions. At least one of the films 3, 4, 5 contains chromium (Cr). In addition, RGB color resins are separately filled in apertures of the black matrix 9. A protective layer 6 and a conductive layer 7 are sequentially formed on the RGB color resins and the black matrix 9. The protective layer 6 functions as a layer flattening the color filter 1, and as an insulator.

In manufacturing of the color filter 1, firstly, the black matrix 9 having a plurality of apertures is formed on the transparent substrate 2 using exposing and developing technology. Then the RGB color resins are repeatedly and respectively filled in the apertures of the black matrix 9, so that every three adjacent apertures have three different color resins and cooperatively define a pixel. Then the protective layer 6 is formed on the RGB color resins and the black matrix 9, to provide an even outer surface for the color filter 1.

The multi-layer antireflection structure of the black matrix 9 can decrease the optical reflectivity of the surface thereof adjacent the transparent substrate 2. However, the optical reflectivity of the other surface thereof opposite to the transparent substrate 2 is still generally too great. That is, the optical reflectivity of the outer surface of the metal screening film 5 is too great. When the black matrix 9 is used in an LCD device, back light beams are reflected by the outer surface of the metal screening film 5 to an excessive degree. This creates light interference, which reduces the visibility of the LCD device.

Therefore, it is desired to obtain a color filter with low reflectivity on both surfaces thereof, and to obtain an LCD device incorporating such color filter.

### SUMMARY OF THE INVENTION

According to one aspect of the present invention, a preferred A color filter (3) includes a substrate (30); a black matrix (31) deposited on the substrate, defining a plurality of apertures therein; a color layer (32) filled in the apertures of the black matrix; an antireflective layer (33) deposited on the black matrix; and a transparent conductive layer (34) covering the color layer and the antireflective layer.

According to another aspect of the present invention, a preferred method of manufacturing a color filter has processes of: providing a transparent substrate; forming a black matrix on the transparent substrate, the black matrix being discontinuously distributed thereon; forming a color layer on the substrate including the black matrix; forming an antireflective layer on the black matrix; and forming a transparent conductive layer on the color layer and the antireflective layer.

According to another aspect of the present invention, a preferred liquid crystal display includes a first substrate; a second substrate opposite to the first substrate; a liquid crystal layer sandwiched between the first and the second substrate; a black matrix deposited on the substrate, defining a plurality of apertures therein; a color layer filled in the apertures of the black matrix; an antireflective layer deposited on the black matrix; and a transparent conductive layer covering the color layer and the antireflective layer.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a schematic, cross-sectional view of a part of a color filter according to a preferred first embodiment of the present invention, the color filter having an antireflective film;

FIG. 2 is a schematic, cross-section view of a part of the antireflective film;

FIG. 3 is a schematic, cross-section view of a part of an alternate antireflective film;

FIG. 4 is a schematic, cross-section view of a part of an another alternate antireflective film;

FIG. 5 is a flow chart of a method of manufacturing the color filter of FIG. 1, according to a preferred second embodiment;

FIG. 6 is a flow chart of an alternate method of manufacturing the color filter of FIG. 1, according to a preferred third embodiment;

FIG. 7 is a schematic, cross-sectional view of a part of an LCD device incorporating the color filter of FIG. 1, according to a preferred fourth embodiment;

FIG. 8 is a schematic, cross-sectional view of a part of a conventional color filter; and

FIG. 9 is a schematic, cross-sectional view of a part of another conventional color filter.

### DESCRIPTION OF THE PREFERRED EMBODIMENTS

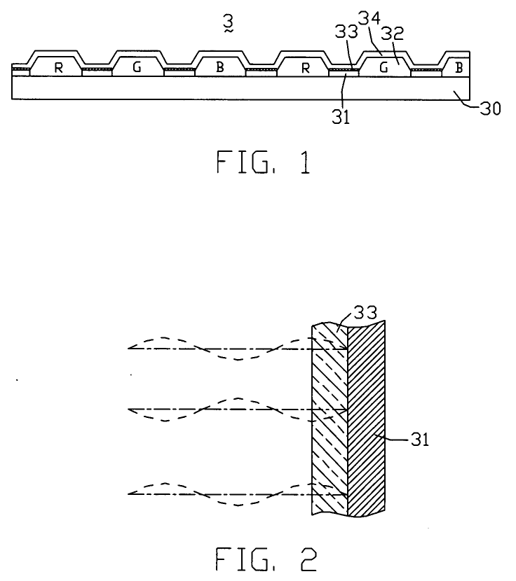

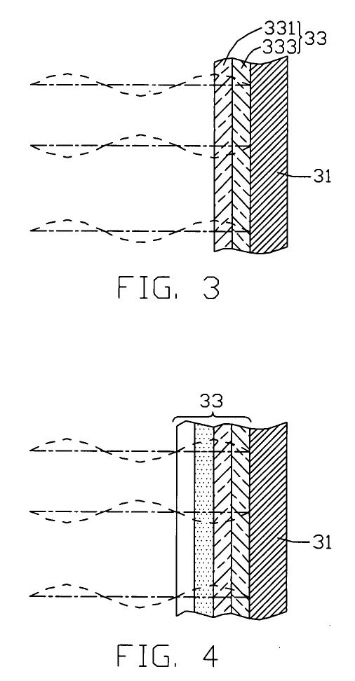

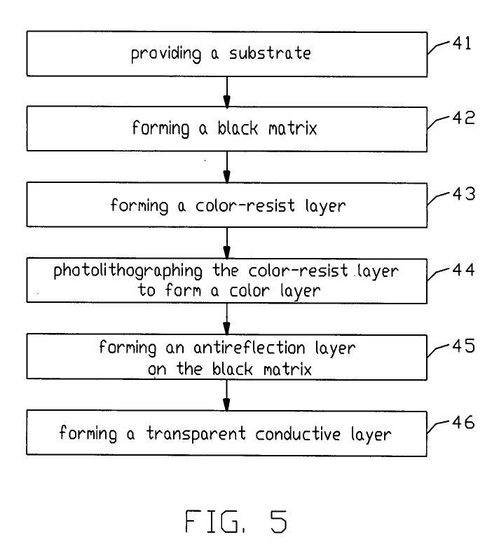

FIG. 1 shows a schematic, cross-sectional view of a color filter according to a first embodiment of the present invention. The color filter 3 includes a transparent substrate 30 with a black matrix 31 deposited thereon, the black matrix 31 defining a plurality of apertures (not labeled) therein. A color layer 32 is filled in the apertures of the black matrix 31 in a sequential repeating pattern, which is a RGB color resins, and an antireflective film 33 are deposited on the black matrix 31. The Color layer 32 filter light beams passing therethrough, thus producing respective RGB color light beams. In addition, a transparent electrode layer 34 is provided on the RGB colr resins 32 and the antireflective film 33.

The transparent substrate 30 is generally made from glass, which acts as a carrier of the above-mentioned elements. The Color layer 32 consists of three primary colors: red, green, and blue. The Color layer 32 includes a plurality of color groups, and each color group includes three primary color portions: a red portion, a green portion, and blue portion, all arranged in a predetermined pattern. The black matrix 31 is disposed among the primary color portions.

When white light reaches the black matrix 31 and color photo-resist layer 32, the red portion allows red rays to pass therethrough, and blocks other rays from passing therethrough. The green portion allows green rays to pass therethrough, and blocks other rays from passing therethrough. The blue portion allows blue rays to pass therethrough, and blocks other rays from passing therethrough. Thus only three colored rays, namely red, green and blue rays, pass through the Color layer 32.

The black matrix 31 is used to close off light beams from spreading among the primary color portions; that is, to prevent light beams from mixing among the different primary color portions. The black matrix 31 generally is made from chromium or its compounds or nickel. The antireflective film 33 is used to decrease the optical reflectivity of the surface thereof adjacent the black matrix. The transparent conductive layer 34 is used to cooperate with a matrix of thin film transistors (not shown) to control quantities of colored rays passing through the Color layer 32, and thereby to obtain different colors for a displayed image.

Referring to FIG. 2, a cross-sectional view of the antireflective film 33 is shown. The antireflective film 33 is a single-layer thin film, which is made from magnesium fluoride, chromium compounds, molybdenum compounds, nickel compounds, or tungsten compounds. These metal compounds can be metal oxide, metal carbides or metal nitride. According to the theory of destructive interference, when the antireflective film 33 has a thickness equal to (¼+N)×λ, wherein N is an integer and λ is the wavelength of the incident light beams thereat, the reflective light beams by the black matrix 32 has an ½ λ difference in wavelength relative to the incident light beams. Thus, the incident light beams and the reflective light beams occur destructive interference. Because the wavelength of visible light is in a range of 400 nm to 700 nm, the antireflective film 33 has a minimum thickness of 95 nm. In addition, the thickness of the antireflective film 33 should be made less than 2000 nm because the manufacturing technology. That is, the antireflective film 33 has a thickness in a range from 95 nm to 2000 nm. In a preferred embodiment, the antireflective film 33 has a thickness of 130 nm equal to one fourth of wavelength of green light beams.

FIG. 5 shows an alternate antireflective film 33. The antireflective film 33 is double-layer thin film, which has a first antireflective layer 331 and a second antireflective layer 332. The first antireflective layer 331 and the second antireflective layer 332 can be made from magnesium fluoride, chromium compounds, molybdenum compounds, nickel compounds, or tungsten compounds. Specially, the first antireflective layer 331 and the second antireflective layer 332 are made by two different materials. The minimum sum of the thickness of the first antireflective layer 331 and the second antireflective layer 332 is 95 nm.

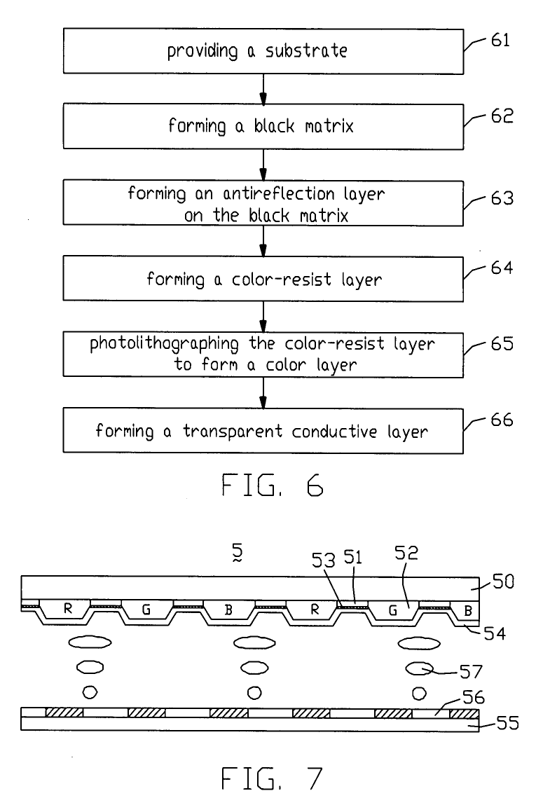

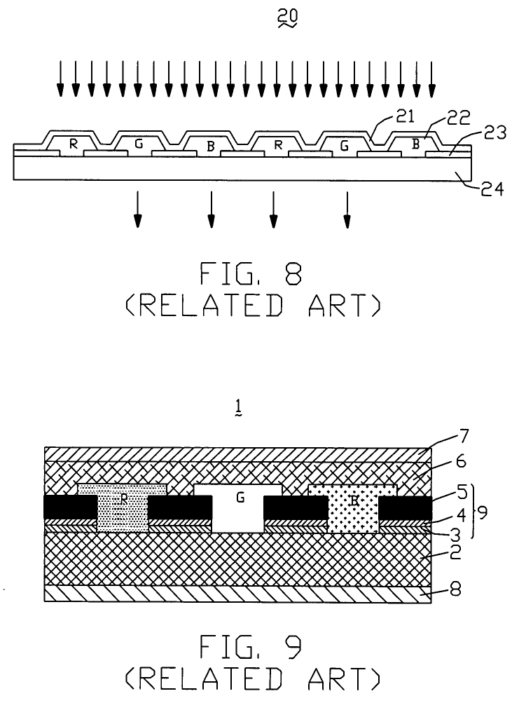

FIG. 6 shows an alternate antireflective film 33. The antireflective film 33 is multi-layer thin film, which has at least three antireflective layers. Each antireflective layer is made from magnesium fluoride, chromium compounds, molybdenum compounds, nickel compounds, or tungsten compounds. Each two adjacent antireflective layers are made by two different materials. The thickness of the antireflective film 33 is equal to (¼+N)×λ, wherein N is an integer and λ is the wavelength of the incident light beams thereat.

FIG. 5 is a flowchart showing a method for manufacturing the color filter 3 according to a preferred second embodiment of the present invention. The method includes the following steps:

step 41: providing the substrate 30;

step 42: forming the black matrix 31;

step 43: forming the color photo-resist layer;

step 44: photolithographing the color photo-resist layer 32 to form a color layer 32;

step 45: forming the antireflective layer 33 on the black matrix 31; and

step 46: forming the transparent conductive layer 34.

In step 41, the substrate 30 acts as a carrier, and usually is made from a fiolax. Of course, the substrate 30 also may be made from glass with a relatively low concentration of alkali ions.

In step 42, the substrate 30 is washed. A metal layer with a uniform thickness is coated on the substrate 30 using a spin coater. Then the metal layer is dried under a low pressure so that some solvent is removed. After that, the metal layer is soft-baked. This removes residual solvent, adds to an adhesive strength of the metal layer, and decreases an internal stress of the metal layer.

Then, the metal layer is photolithographed and developed using a mask and ultraviolet radiation. Chemical properties of the black resin layer change after the irradiation by the ultraviolet rays. The substrate 30 having the metal layer is washed with a developing solution. Irradiated portions of the metal layer are far more soluble than unexposed portions of the black resin layer. Thus the irradiated portions of the metal layer dissolve and are removed, thereby obtaining the black matrix 31, being discontinuously distributed thereon. Then the substrate 30 is hard-baked to remove residual developing solution. This step also improves an anti-etching characteristic of the black matrix 31, increases an adhesive strength of the black matrix 31, and increases a flatness of the black matrix 31.

In step 43, the color photo-resist layer is formed by distributing dyes. In general, the color photo-resist layer 32 derived from a solution for thinning the dyes, a PMMA (Polymethyl Methacrylate) resin, and a photosensitive material. The photosensitive material is a negative photoresist material, and forms a cross linked structure after being irradiated. The cross linked structure can protect a weakly alkaline solution from being eroded, and can help fix the color photo-resist layer on the substrate 30 and black matrix 31.

A photoresist layer (not shown) is coated on the substrate 30, and the photoresist layer is pre-baked to improve its stability.

In step 44, a housing having a liquid mercury contained therein is provided, and the photo-resist layer is set to contact with the liquid mercury. After that, three light sources having three different wavelengths are respectively continuously used to expose the photo-resist layer, cooperating with three different masks having different patterns. Next, a developing solution is provided for removing the unexposed photo-resist layer to form a color-resin pattern having red (R), green (G), and blue (B) patterns. In the process, the liquid mercury functions as a carrier to support the substrate and functions as a reflection mirror to reflect light beams incident thereat to intervene with the incident light beams in the photo-resist layer, which the intervene light beams form color photo-resists. The three light sources are partially temporal coherence light sources, which respectively have the wavelengths of 7×10⁻⁷ meters, 5.46×10⁻⁷ meters, and 4.35×10⁻⁷ meters. Thus, the color layer 30 is formed.

In step 45, the antireflective layer 33 with a uniform thickness is coated on the black matrix 31 using a spin coater. The antireflective layer 33 is made from magnesium fluoride, which has a thickness in a range from 95 nm to 2000 nm. In a preferred embodiment, the antireflective layer 33 has a thickness of 130 nm. The antireflective layer 33 can also be made from chromium compounds, molybdenum compounds, nickel compounds, or tungsten compounds. These metal compounds can be metal oxide, metal carbids or metal nitride.

In step 46, the transparent conductive layer 34 generally includes one or both of Indium Tin Oxide (ITO) and Indium Zinc Oxide (IZO). The transparent conductive layer 34 is usually formed on the substrate 30 by a sputter method. An electric field is created in a vacuum cavity filled with argon gas, such that arc discharge of the argon gas is produced. Argon ions (Ar⁺) with kinetic energy bombard a surface of (say) an ITO target on a cathode. ITO atoms are sputtered onto a surface of the substrate 30 and progressively accumulate to form a film. Additionally, a magnetic field is created, to change a direction of movement of the argon ions. In the magnetic field, magnetic lines of force are parallel to the surface of the ITO target. This increases several-fold the quantity of argon ions bombarding the ITO target. Thus an ITO film can be sputtered onto the substrate 30 at a low temperature even if a pressure of the argon gas is low.

In addition, the color filter 3 can be made by an alternate method shown in FIG. 6, according to a third embodiment of the present invention. The method has similar processes to that of the aforementioned method except that the step of forming the antireflective layer 33 and the step of forming the color photo-resist layer 32 is interchanged. The method includes the following steps:

step 61: providing the substrate 30;

step 62: forming the black matrix 31;

step 63: forming the antireflective layer 33 on the black matrix 31; and

step 64: forming the color photo-resist layer;

step 65: photolithographing the color photo-resist layer to form a color layer 32; and

step 66: forming the transparent conductive layer 34.

FIG. 7 shows a liquid crystal display (LCD) according to an embodiment of the present invention. The LCD 5 has a first substrate 50, a second substrate 55 opposite to the first substrate 50, and a liquid crystal layer 57 sandwiched between the first and the second substrates 50, 55. The first substrate 50 has a black matrix 51 deposited thereon, the black matrix 51 defining a plurality of apertures (not labeled) therein. RGB color resins 52 are filled in the apertures of the black matrix 51 in a sequential repeating pattern, and an antireflective film 53 are deposited on the black matrix 31. The RGB color resins 52 filter light beams passing therethrough, thus producing respective RGB color light beams. In addition, a transparent electrode layer 54 is provided on the RGB color resins 52 and the antireflective film 53.

The second substrate 55 has a thin film transistor (TFT) electrode matrix 56 formed thereon, facing the transparent electrode layer 54. The transparent conductive layer 54 is used to cooperate with the TFT electrode matrix 56 to control quantities of colored rays passing through the RGB color resins 52, and thereby to obtain different colors for a displayed image.

In operation of the LCD 5, the TFT electrode matrix 56 and transparent electrode layer 54 are connected with an IC (Integrated Circuit) device (not shown) to control rotation of liquid crystal molecules in the liquid crystal layer 57, and thereby control the passage or blocking of light beams. Back light beams emitted by an illuminator (not shown) pass through the second substrate 55 and the TFT electrode matrix 56 of the LCD 5, and enter the liquid crystal layer 57. Most of the light beams pass through the liquid crystal layer 57, are filtered by the color resin layer 52, and emit from an outer surface (not labeled) of the first substrate 50. A remainder of the light beams pass through the liquid crystal layer 57, but are blocked by the black matrix 53.

The LCD 5 utilizes the theory of superposition of light waves at the antireflective layer 53, the light beams impinging on an outer surface of the antireflective layer 53 on the black matrix 51 are mostly absorbed by the antireflective layer 53 rather than being reflected by the black matrix 51. Thus the phenomenon of light interference is diminished. That is, the OD value of the black matrix 51 is increased, and the visibility of the LCD device 5 is improved. Accordingly, the LCD device 5 using the antireflective layer 53 provides high brightness and contrast.

It is to be understood, however, that even though numerous characteristics and advantages of the present invention have been set forth in the foregoing description, together with details of the steps and associated structures of the invention, the disclosure is illustrative only, and changes may be made in detail, especially in matters of arrangement of procedures and related objects within the principles of the invention to the full extent indicated by the broad general meaning of the terms in which the appended claims are expressed.

1. A color filter comprising:
a substrate;
a black matrix deposited on the substrate, defining a plurality of apertures therein;
a color layer filled in the apertures of the black matrix;
an antireflective layer deposited on the black matrix; and
a transparent conductive layer covering the color layer and the antireflective layer.

2. The color filter as claimed in claim 1, wherein the antireflective layer is made from magnesium fluoride, chromium compounds, molybdenum compounds, nickel compounds, or tungsten compounds.

3. The color filter as claimed in claim 1, wherein the antireflective layer has a thickness in a range from 95 nm to 2000 nm.

4. The color filter as claimed in claim 1, wherein the antireflective layer is a single layer structure, a double-layer structure, or a multi-layer structure.

5. The color filter as claimed in claim 1, wherein the antireflective film has a thickness equal to (¼+N)×λ, in which N is an integer and λ is the wavelength of the incident light beams thereat.

6. The color filter as claimed in claim 1, wherein the color layer has RGB color resins filled in the apertures of the black matrix in a sequential repeating pattern.

7. The color filter as claimed in claim 1, wherein the black matrix is made from chromium or its compounds or nickel.

8. A method of manufacturing a color filter, comprising:
providing a transparent substrate;
forming a black matrix on the transparent substrate, the black matrix being discontinuously distributed thereon;
forming a color layer on the substrate including the black matrix;
forming an antireflective layer on the black matrix; and
forming a transparent conductive layer on the color layer and the antireflective layer.

9. The method as claimed in claim 8, wherein the step of forming a color layer on the substrate including the black matrix and the step of forming an antireflective layer on the black matrix are interchangeable.

10. The method as claimed in claim 8, wherein the antireflective layer is magnesium fluoride, chromium compounds, molybdenum compounds, nickel compounds, or tungsten compounds.

11. The method as claimed in claim 8, wherein the antireflective layer has a thickness in a range from 95 nm to 2000 nm.

12. The method as claimed in claim 8, wherein the antireflective layer is a single layer structure, a double-layer structure, or a multi-layer structure.

13. The method as claimed in claim 8, wherein the antireflective film has a thickness equal to (¼+N)×λ, in which N is an integer and λ is the wavelength of the incident light beams thereat.

14. The method as claimed in claim 8, wherein the color layer has RGB color resins filled in the apertures of the black matrix in a sequential repeating pattern.

15. The method as claimed in claim 8, wherein the black matrix is made from chromium or its compounds or nickel.

16. A liquid crystal display, comprising:
a first substrate;
a second substrate opposite to the first substrate;
a liquid crystal layer sandwiched between the first and the second substrate;
a black matrix deposited on the substrate, defining a plurality of apertures therein;
a color layer filled in the apertures of the black matrix;
an antireflective layer deposited on the black matrix; and
a transparent conductive layer covering the color layer and the antireflective layer.

17. The liquid crystal display as claimed in claim 16, wherein the antireflective layer has a thickness in a range from 95 nm to 2000 nm.

18. The color filter as claimed in claim 16, wherein the antireflective layer is a single layer structure, a double-layer structure, or a multi-layer structure.

19. The liquid crystal display as claimed in claim 16, wherein the antireflective film has a thickness equal to (¼+N)×λ, in which N is an integer and λ is the wavelength of the incident light beams thereat.

20. The liquid crystal display as claimed in claim 16, wherein a TFT (thin film transistor) matrix is provided on the second substrate, facing the transparent conductive layer.
